(19) United States
(12) Patent Application Publication
(10) Pub. No.: US 2020/0009580 A1
(43) Pub. Date: Jan. 9, 2020

(54) SYSTEMS AND METHODS FOR DETECTING THE STATUS OF AN ELECTROSTATIC FILTER

(71) Applicant: KONINKLIJKE PHILIPS N.V., EINDHOVEN (NL)

(72) Inventors: ACHIM GERHARD ROLF KOERBER, EINDHOVEN (NL); RAINER HILBIG, AACHEN (NL); JOHANNES MARRA, EINDHOVEN (NL); CORNELIS REINDER RONDA, AACHEN (NL)

(21) Appl. No.: 16/470,427

(22) PCT Filed: Dec. 21, 2017
(86) PCT No.: PCT/EP2017/084118

§ 371 Date: Jun. 17, 2019

(30) Foreign Application Priority Data
Dec. 21, 2016 (EP) 16205692.3

(51) Int. Cl. B03C 3/76; B03C 3/68

(52) U.S. Cl. CPC B03C 3/763; B03C 3/68

(57) ABSTRACT

Presented is an air cleaning system, comprising: an electrostatic precipitation air filter comprising a collector electrode, a repeller electrode and a corona wire; a detection system for detecting particles; characterized in that: the detection system is configured to determine a status of the electrostatic precipitation filter from an amount of particles present on the collector electrode. Further presented are methods for determining a status of an electrostatic precipitation air filter and methods for determining a particle size distribution in air.

### FIELD OF THE INVENTION

The present invention relates to methods and systems for detecting the life-time of electrostatic based air filters. Other aspects of the invention relate to systems and methods for particle detection,

### BACKGROUND OF THE INVENTION

State of the art air purification systems remove particles by blowing air through a particle filter. Electro Static Precipitation (ESP) is another well-known technology for removing particles from air. Corona discharges in the vicinities of thin corona wires on high DC voltage act as sources of unipolar gas molecule ions which in turn are charging the airborne particles. An array of collecting and repelling electrodes are put on opposite HV voltages and are located downstream of the corona wires for effectively removing the charged particles from the airflow. Over time, due to particle build up inside the device, the efficiency of the air filtration decreases.

Current products on the market do not provide an indication when an ESP device should be cleaned. An uncleaned ESP device leads to less efficient filtering without knowledge of the user.

Further, when ESP devices are not cleaned in time, they suffer from “back-corona” breakthrough events leading to inconvenient sound generation.

Another problem related to state of the art ESP devices is the development of smell related to the deposition of, for example, cigarette or other smoke constituents in the device.

There is a need for an ESP device which automatically detects when the device should be cleaned and notifies the user before the filter efficiency is at an unacceptable level; before back-corona” breakthrough events take place; or before unacceptable smells start to develop.

U.S. Pat. No. 5,679,137A describes a cell sensor for an electronic air cleaner. An optical detection mechanism is used to determine the amount of dirt that gathers in a hole in the cleaner. U.S. Pat. No. 5,679,137A is silent on detecting particles in air to determine the status of an air filter.

US 2010/037767A1 describes a method for determining the dust load of an ESP device. It is described that sparking rates relate to the presence of dust on electrostatic plates. US 2010/037767A1 is silent on detecting dust particles in air to determine the status of an air filter.

### SUMMARY OF THE INVENTION

In an aspect, an air cleaning system is presented, comprising: an electrostatic precipitation air filter comprising a collector electrode, a repeller electrode and a corona wire; a detection system for detecting particles; wherein the detection system is configured to determine a status of the electrostatic precipitation filter from an amount of particles present on the collector electrode.

The detection system comprises: an actuating component configured for actuating the collector electrode such that present or gathered particles on the collector electrode are detached from the collector electrode when activated. The detection system further comprises a detector configured to determine the amount of particles present on the collector electrode from detached collector electrode particles, e.g. from detached collector electrode particles in air.

According to an embodiment, the detection system is configured to: switch off the corona wire voltage, switch off the collector electrode voltage and switch off the repeller electrode; thereafter activate the actuating component to detach particles from the collector electrode; thereafter optically detect the amount of the detached particles in a particle cloud generated or created by detaching particles from the collector electrode.

According to an embodiment, the detection mechanism is configured to: switch off the corona wire voltage and maintain the collector electrode voltage and maintain the repeller electrode voltage; thereafter activate the actuating component to detach particles from the collector electrode; thereafter analyze the collector electrode current signal to determine the amount of the detached particles.

According to an embodiment, the detection system is further configured to determine particle size distribution of the detached particles by relating different current pulses of the collector electrode current signal over time to different particle sizes.

According to an embodiment, the detection mechanism is configured to: switch off the corona wire voltage, switch off the collector electrode voltage and switch off the repeller electrode; thereafter activate the actuating component to detach particles from the collector electrode; thereafter supply the collector electrode with a voltage level equal to the repeller electrode voltage level before switch-off and supplying the repeller electrode with a voltage level equal to the collector electrode voltage level before switch-off, and analyze the repeller electrode current signal to determine the amount of the detached particles.

According to an embodiment, the detection system is further configured to determine particle size distribution of detached particles by relating different current pulses of the repellent electrode current signal over time to different particle sizes.

According to an embodiment, the actuating component is a vibrating component. For example, an ultrasound transducer. The actuating component is positioned on or near the collector electrode such that it may actuate, e.g. vibrate, the collector electrode when activated. The force of the actuating component is selected such that gathered dust on the collector electrode can be detached from the collector electrode.

In an aspect of the invention, a method for determining a status of an electrostatic precipitation air filter featuring a collector electrode, a repeller electrode and a corona wire is presented, the method comprising: determining a status of the precipitation air filter by: firstly determining an amount of gathered particles on the collector electrode; and secondly determining the status of the electrostatic precipitation air filter based on the determined amount of gathered particles. Determining the amount of gathered particles present on the collector electrode comprises: detaching the gathered particles from the collector electrode thereby forming a particle cloud in air; and determining the amount of particles in the particle cloud.

According to an embodiment, the method further comprises: switching off the corona wire voltage, switching off the collector electrode voltage and switching off the repeller electrode voltage supplied to the different components of the electrostatic precipitation air filter prior to the detaching of the gathered particles from the collector electrode, and wherein determining the amount of particles in the particle cloud is done by performing optical detection on the particle cloud.

According to an embodiment, the method further comprises: switching off the corona wire voltage and maintaining the collector electrode voltage and maintaining the repeller electrode voltage supplied to the different elements of the electrostatic precipitation air filter prior to the detaching of the gathered particles from the collector electrode, and wherein the amount of particles in the particle cloud is determined from the collector electrode current signal.

In embodiments where current signals at the collector or repellent electrode are monitored for detecting the amount of particles on the collector electrode or to detect one or more types of particles present on the collector electrode, the detection system may comprise a device for measuring current signals. For example, a current measurement device coupled to the collector electrode. The detection system may further comprise a processor or a controller configured for analyzing a current signal measured by the current measurement device.

In an aspect of the invention, a method for determining particle size distribution is presented comprising the method for determining a status of an electrostatic precipitation air filter wherein the amount of particles in the particle cloud is determined from the collector electrode current signal. The particle size distribution of detached particles is determined by relating different current pulses of the collector electrode current signal over time to different particle sizes.

According to an embodiment, the method for determining particle size distribution further comprises: switching off the corona wire voltage, switching off the collector electrode voltage and switching off the repeller electrode voltage prior to the detaching of the gathered particles from the collector electrode, and supplying the collector electrode with a voltage level equal to the repeller electrode voltage before switch-off and supplying the repeller electrode with a voltage level equal to the collector electrode before switch-off after the detaching of the gathered particles from the collector electrode, and wherein the amount of particles in the particle cloud is determined from the repeller electrode current signal.

In an aspect of the invention, a method for determining particle size distribution is presented, comprising the method for determining a status of an electrostatic precipitation air filter wherein the amount of particles in the particle cloud is determined from the repeller electrode current signal. The particle size distribution of detached particles is determined by relating different current pulses of the repellent electrode current signal over time to different particle sizes.

According to an embodiment, the detaching of the gathered particles from the collector electrode is performed by vibrating the collector electrode.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 illustrates a system for cleaning or purifying air according to an embodiment

FIG. 2 illustrates the current on the collector electrode in an embodiment

FIG. 3 illustrates the current on the repeller electrode in an embodiment

FIG. 4 illustrates the recollected fraction of particles vs time for a 1 m/s start velocity of the particles

FIG. 5 illustrates the recollected fraction of particles vs time for a 10 m/s start velocity of the particles

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF THE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Throughout the description, reference is made to “particles”. This may refer to dust or tiny particles of different sizes such as PM2.5 or PM10 particles, but also particles having a diameter smaller than 1 μm.

Throughout the description, reference is made to “detached collector electrode particles”. These are the particles that gathered over time or were originally present on the collector electrode and are now detached from the collector electrode through actuation, e.g. vibration, of the collector electrode.

Throughout the description, reference is made to actuating the collector to detach particles from the collector electrode. This means that the collector electrode is actuated in such a way that particles become airborne, e.g. by vibrating the collector electrode.

The invention solves the aforementioned problems by detecting an amount of particles, e.g. dust, gathered on the collector electrode over time and relating the amount of particles to the status of the ESP device. The status information may be used to notify the user when the ESP device needs to be cleaned.

Detailed embodiments are described below.

In an aspect of the invention, a system for cleaning or purifying air is presented, e.g. an air cleaning system. The system features an electrostatic precipitation air filter which comprises at least one collector electrode, at least one repeller electrode and at least one corona wire. The air filter may comprise a plurality of corona wires, collector electrodes and repellent electrodes. The air filter is adapted such that corona discharges in the vicinities of the at least one corona wire on high DC voltage act as sources of unipolar gas molecule ions which in turn are charging the airborne particles. The air filter is further adapted such that the at least one collector electrode and the at least one repeller electrode are put on opposite HV voltages and are located downstream of the corona wires for effectively removing the charged particles from the airflow. The air filter is placed in a conduit of the system such that air passing through the conduit can be filtered by the air filter. In an embodiment, the air filter is adapted such that an ionic wind is generated in the conduit. The adaptation may comprise selecting and positioning the corona wire(s), collector and repellent electrode(s) to achieve this technical effect. Such adaptations are known to a person skilled in the art. As an advantage, no additional fan is required to propagate particles through the conduit.

The system further comprises a detection system for detecting particles on the collector electrode. These particles are dust particles that gathered on the collector electrode over time and influence the filter efficiency of the air filter. The detection system is configured for determining a status of the electrostatic precipitation filter from a detected amount of particles present on the collector electrode.

It is an advantage of the invention that by detecting the amount of particle deposition, e.g. dust, on the collector electrode, at an early stage it can be notified to the user that the ESP device should be cleaned to avoid unacceptable filter efficiency; disturbing “back-corona” breakthrough events or the development of smell from deposited constituents such as cigarette smoke constituents.

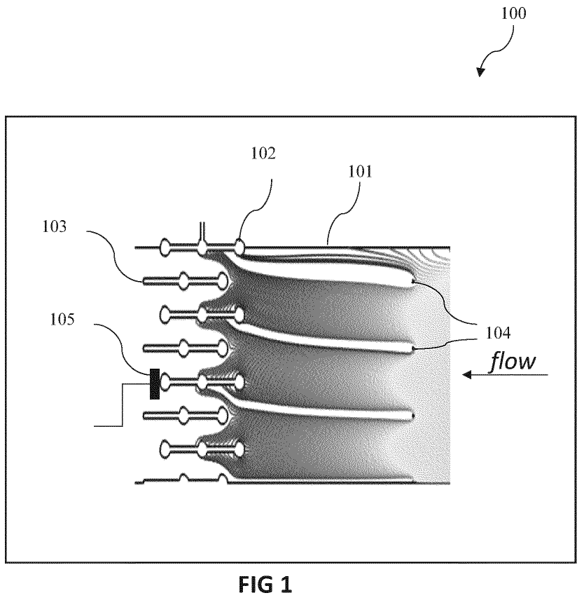

FIG. 1 illustrates an ESP device 100 with corona wires 104; collector electrodes 102 and repellent electrodes 103. These components are located in an air conduit such that particles present in an air flow propagating through the conduit are first charged using the corona wire and then precipitate on the collector electrodes 102 by adapting the voltages on the collector electrodes 102 and the repellent electrodes 103. These components form the air filter 101. Further, on one of the collector electrodes 102 an actuating component 105 is positioned for actuating the collector electrode 102 to detach collected particles from the collector electrode 102 when activated. In certain embodiments, in close proximity of the actuating component, a sensor is present to perform sensing of particles detached from the collector electrode 102.

According to an embodiment of the invention, the status of the electrostatic precipitation filter is notified to the user, e.g. on a display or via a sound/alarm of the system. According to an embodiment of the invention, the system notifies the user when the amount of detected particles present on the collector electrode exceeds a pre-defined threshold. The pre-defined threshold relates to an allowable/acceptable amount of particles present on the collector electrode. At this pre-defined threshold, there is no development of smell nor occurrence of “back-corona” breakthrough events nor unacceptable filter efficiency. The pre-defined threshold may be defined beforehand during experiments where it is determined at what amount of particles on the collector electrode the different problems start to occur.

According to an embodiment of the invention, the detection system comprises an actuating component configured for actuating the collector electrode such that, when activated, particles present on the collector electrode are detached from the collector electrode and become airborne. For example, the actuating component may be a vibrating component that is positioned such that when activated the collector electrode is brought in vibration and particles gathered on the collector electrode over time are shaken off and become airborne inside the system. The actuating component may be an ultrasound transducer, e.g. an ultrasound piezoelectronic transducer. The actuating component may be positioned on or mechanically coupled to the collector electrode. The aim of the actuating component is to free up or release only a small amount of the gathered particles on the collector electrode and not to use this as a cleaning step of the system. Further, the detection system comprises a detector or sensor configured to determine the amount of particles present on the collector electrode from detached collector electrode particles in air. Thus, the detector is positioned and configured to detect the amount of particles shaken off from the collector electrode by actuating the collector electrode using the actuating component. In other words, the detector detects the amount of particles in a generated particle cloud from the collector electrode, the particle cloud being generated by actuating the collector electrode.

According to an embodiment, the order of magnitude of the force that the actuating component exerts on the collector electrode for detaching gathered particles from the collector electrode is selected such that detached or shaken-off particles have a minimum velocity of 0.5 m/s. For example, the velocity of detached or shaken-off particles is between 0.5 m/s and 5 m/s. It was determined that such velocities allow good detection of particles. The order of magnitude of the force may be determined beforehand in a series of experiments where different types of particles are exposed to different forces.

According to an embodiment, the detection system comprises a controller, e.g. a processor, for controlling the different voltages supplied to the corona wire(s), the collector and the repellent electrode(s). This controller may be used to implement the different detection techniques as described in this disclosure by regulating voltages supplied to the different components of the system.

According to an embodiment of the invention, the detection system is configured to: switch off the corona wire voltage, switch off the collector electrode voltage and switch off the repeller electrode; thereafter activate the actuating component to detach particles from the collector electrode; and thereafter optically detect the amount of the detached particles.

Thus, in first instance all high voltages of the corona wire, collector electrode and repeller electrode are switched off. In second instance, the actuating component coupled to the collector electrode is activated to make gathered particles on the collector electrode airborne by, for example, vibrating the collector electrode such that a particle cloud is formed. In third instance, the amount of particles in the particle cloud is detected using an optical particle detector, e.g. by analyzing scattered light of a laser beam directed into the particle cloud. To optically detect the amount of particles a “Self Mixing Interference” (SMI) principle using a Vecsel laser diode may be used. The use of this principle is advantageous as it requires only one optical element acting at the same time as light source and detector.

According to an embodiment of the invention, the detection mechanism is configured to: switch off the corona wire voltage but maintain the collector electrode voltage and maintain the repeller electrode voltage; thereafter activate the actuating component to detach particles from the collector electrode; thereafter analyze the collector electrode current signal to determine the amount of the detached particles.

In this embodiment, the detection technique is based on the concept that particles shaken-off from the collector electrode by, for example an ultrasound pulse, are charged by the gas ions in front of the collector. The charged particles are then accelerated towards a chosen detection electrode, being a collector or repeller electrode, where they are registered in the form of a current pulse.

Thus, the functionality is as following:

1) The corona wire voltage is switched off completed in a time shorter than 1 ms. Preferably, the corona wire voltage switch off is completed in a time shorter than 0.1 ms. A fast switch-off, e.g. smaller than 0.1 ms, is preferred because the signal-to-background for particle detection is in that case better.

2) Thereafter, the activating component is activated with an activating signal for a short period of time, for example shorter than 1 ms. For example, the activating signal, represented by a short electric pulse, is delivered to an ultrasound transducer acting as the actuating component to shake-off or stir up particles from the collector electrode. This electric pulse is well synchronized with the moment of switching off the corona wire voltage. For example, the electric pulse is delivered within 1 ms after switch off of the corona wire voltage. The technical effect of this synchronization between the activating signal and the switch off of the corona wire voltage is that particles can easily be separated from a strong background of the corona current. If the activating signal is too early, the current pulses from the particles are difficult to be separated from the strong background of the corona current. If the activating signal is too late, all gas ions are already re-captured by the collector electrode and the shaken-off particles cannot be charged anymore.

3) Thereafter, current pulses corresponding to the shaken-off and charged particles as peaks on the exponentially decaying background of re-captured gas ions are measured.

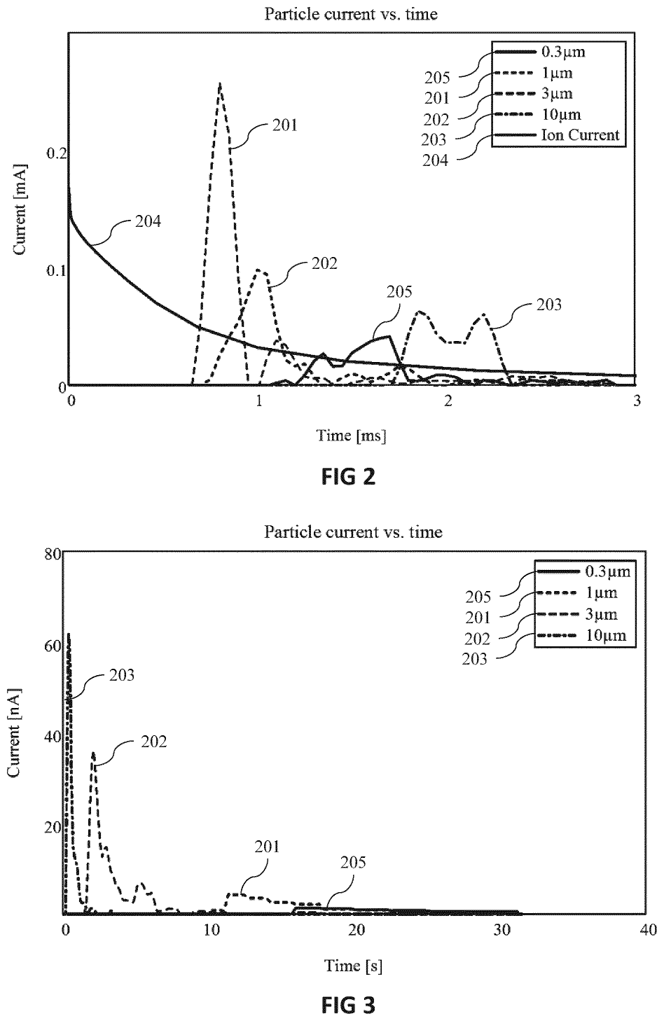

FIG. 2 illustrates the measured current on the collector electrode during an experiment. The different current pulses relate to re-collected particles on the collector electrode. The horizontal axis represents time after switch-off of the corona wire voltage and the activation signal. FIG. 2 shows that particles with a diameter of about 3 μm will be re-collected within the shortest time (˜0.8 ms), whereas both smaller and larger particles will need a longer time (up to ˜2.5 ms) to travel back to the collector electrode. It is further shown that the amplitude of current pulses due to re-collected particles may be in the order of 10⁻⁵ to 10⁻⁴ A, which can easily be measured compared to detection difficulties in prior art techniques. The information on re-collection time and current amplitude may be used to differentiate between different particles.

According to an embodiment, the detection system is further configured to determine particle size distribution of the detached particles by relating different current pulses of the collector electrode current signal over time to different particle sizes. Thus, the device may be used to determine which type of particles propagate through the air filter and thus are present in the air. This is illustrated in FIG. 2 which shows the different current curves and its peaks over time which relate to different particle sizes.

According an embodiment, the detection mechanism is configured to: switch off the corona wire voltage, switch off the collector electrode voltage and switch off the repeller electrode; thereafter activate the actuating component to detach particles from the collector electrode; thereafter supply the collector electrode with the repeller electrode voltage level before switch-off and supplying the repeller electrode with the collector electrode voltage level before switch-off; and thereafter analyze the repeller electrode current signal to determine the amount of the detached particles or, alternatively, determine the amount of the detached particles using an optical detector.

Thus, the functionality is as following:

1) All voltages are switched off, including corona wire, collector electrode and repeller electrode voltages. The switch-off of the voltages is ideally completed in a time shorter than 1 ms. Preferably the switch off is performed in a time shorter than 0.1 ms.

2) Thereafter, the activating component is activated using an activating pulse. This pulse may be 10 ms or shorter. For example, a short electric pulse is delivered to an Ultrasound transducer which is mechanically coupled to a collector electrode to shake-off particles from this electrode. The synchronization of this activating signal with the switch-off of the voltages is less critical than in the previously described embodiment because the gas ions needed for particle charging are staying within the volume for a much longer time as they are not attracted towards the collector electrodes.

3) Thereafter, the repeller electrodes voltage is set to the voltage level that the collector electrode had during the corona discharge and the collector electrodes voltage is set to the voltage level that the repellent electrode had during the corona discharge. This can be achieved by, for example, putting the ESP collector electrode on reversed voltage. The timing of this voltage reversal is not critical, but the delay Δtdel between the switch-off of all voltages and switch-on of reversed ESP voltages should be within the range 0-10 ms. Now the gas ions and the particles will have to drift from the volume in front of the shaken collector electrode towards the nearest repeller electrodes. Since the distance between collector and repeller electrodes is selected to be in the order of mm, the drift time of the particles will be in the order of 0.1 to 30 seconds. The distance dCR between collector and repeller electrodes is related to their relative voltage difference ΔVCR. The corresponding average electric field strength approximately corresponds to ΔVCR/dCR=1 kV/mm. An advantage is that detection electronics does not have to be that fast. This is also an advantage with respect to determining the particle size distribution. Furthermore, if the particles travel longer distances (in the order of mm), this allows easier optical detection of the particles.

4) Thereafter, the shaken-off, charged particles are registered as current pulses measured at the nearest repeller electrodes or, alternatively, are optically detected using an optical sensor.

FIG. 3 shows the current at the repeller electrode during an experiment. The horizontal axis represents the time after switch-off & activating signal. Different curves represent different particle diameters. Compared to FIG. 2, the magnitude of the current pulses is about 3 orders of magnitude lower because the widths of the current pulses are 3 orders of magnitude larger (seconds in place of milliseconds). As an advantage, various particle sizes are easily discriminated. Thus, also for this embodiment, the detection system may be configured to determine particle size distribution of detached particles by relating different current pulses of the repellent electrode current signal over time to different particle sizes. Thus, the device may function as particle detector and be used to determine which type of particles propagate through the air filter and thus are present in the air.

In an aspect of the invention, a particle sensor is presented. The particle sensor features at least one collector electrode, at least one repeller electrode and at least one corona wire. The at least one collector electrode, at least one repeller electrode and at least one corona wire are adapted such that corona discharges in the vicinities of the at least one corona wires on high DC voltage act as sources of unipolar gas molecule ions which in turn are charging the airborne particles. The particle sensor is further adapted such that, when activated, the at least one collector electrode and the at least one repeller electrode are put on opposite HV voltages and are located downstream of the corona. The at least one collector electrode, at least one repeller electrode and at least one corona wire are placed in an air conduit. In this air conduit, the at least one collector electrode, at least one repeller electrode and at least one corona wire may be arranged to generate an ionic wind in the air conduit. This removes the need for an additional fan to create an airflow.

The particle sensor further comprises a detection mechanism for detecting particles on the collector electrode. The detection system is configured for detecting types of particles gathered on the collector electrode. In an embodiment of the particle sensor, the detection system comprises: an actuating component configured for actuating, e.g. vibrating, the collector electrode such that present particles on the collector electrode are detached or shaken off from the collector electrode when the actuating component is activated; and a detector configured to determine the type of particles present on the collector electrode from the detached collector electrode particles. As described in the other aspects and embodiments, the detection may be done by analyzing current pulses on the collector or repellent electrode caused by recollected particles on these electrodes. The recollected particles are particles which are firstly shaken off from the surface of the collector electrode and secondly return back on the surface of the collector or repellent electrode depending on the applied voltages on these electrodes. As described in the other aspects and embodiments, the actuating components exerts a force on the collector electrode for detaching or shaking off particles from the collector electrode.

According to an embodiment, the detection is done by switching off the corona wire voltage and maintain the collector electrode voltage and the repeller electrode voltage; thereafter activate the actuating component to detach particles from the collector electrode; thereafter analyze the collector electrode current signal to determine the type of the particles.

According to an embodiment, a further particle size distribution can be performed by relating the different current pulse signals from the collector electrode measured over time to different particle types.

According to an embodiment of the invention, the detection is done by switching off the corona wire voltage, switch off the collector electrode voltage and switch off the repeller electrode; thereafter activate the actuating component to detach particles from the collector electrode; thereafter supply the collector electrode with the repeller electrode voltage level which was supplied to the collector electrode before switch-off and supplying the repeller electrode with the collector electrode voltage level which was supplied to the repeller electrode before switch-off, and analyze the repeller electrode current signal to determine the type of the particles.

According to an embodiment, a further particle size distribution can be performed by relating the different current pulse signals from the repeller electrode measured over time to different particle types.

In an embodiment of the invention, the actuating component is configurable such that the magnitude of the force, e.g. vibration, exerted on the collector electrode is adapted to the type of particle that should be detected. In other words, the magnitude of the force generated by the actuating component and exerted on the collector electrode is adaptable or adapted to the particle type, e.g. particle size. A controller may be coupled to the actuating component for adjusting the magnitude of the force generated by the actuating component to the particle type. For example, the controller is configured to supply a particular voltage level to the actuating component; the voltage level being adapted to the particle type that must be detected.

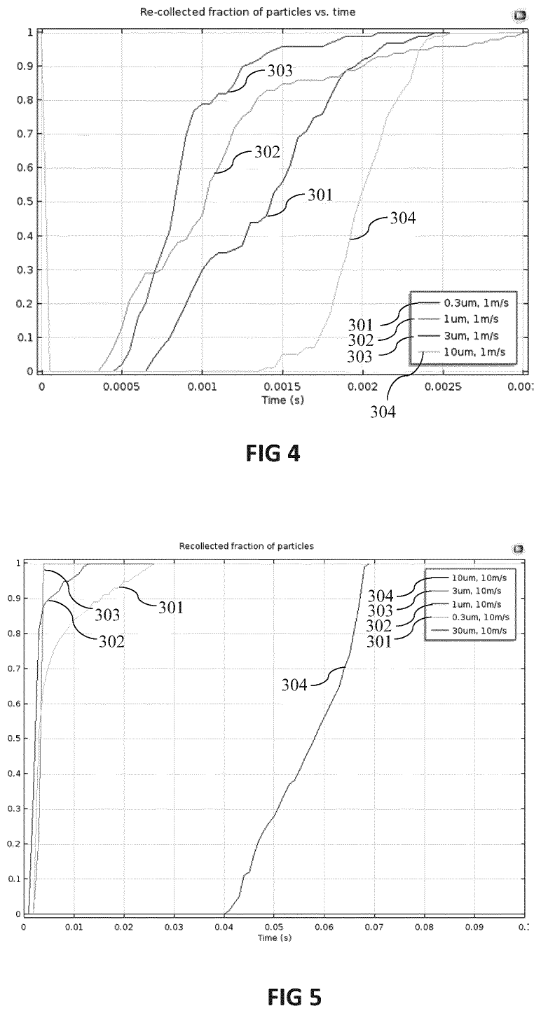

For example, for smaller sized particles the magnitude of the force may be increased to detect small particles more accurately. Vice versa, for larger sized particles the magnitude of the force may be decreased to detect large particles more accurately. This is illustrated in FIG. 4 and FIG. 5. FIG. 4 illustrates the recollected fraction of particles vs time for a 1 m/s start velocity. FIG. 5 illustrates the recollected fraction of particles vs time for a 10 m/s start velocity. As can be noticed in FIG. 5, particles 304 having a size of 10 um can more accurately be distinguished from particles having a smaller size 301, 302, 303 compared to the graphs in FIG. 4. Hence, accuracy of specific particle detection can be increased by adapting the particle velocity to the specific particle type that must be detected.

Any of the embodiments described in the context of the air cleaning system also apply to a particle detector and may be implemented in such a particle detector.

1. An air cleaning system, comprising:
an electrostatic precipitation air filter comprising a collector electrode, a repeller electrode and a corona wire; and
a detection system for detecting particles; wherein the detection system is configured to determine a status of the electrostatic precipitation filter from an amount of particles present on the collector electrode; and wherein the detection system comprises:
an actuating component configured for actuating the collector electrode such that present particles on the collector electrode are detached from the collector electrode when activated;
a detector configured to determine the amount of particles present on the collector electrode from detached collector electrode particles in air.

2. The air cleaning system according to claim 1,
wherein the detection system is configured to:
switch off the corona wire voltage, the collector electrode voltage and the repeller electrode voltage; thereafter
activate the actuating component to detach particles from the collector electrode; thereafter
optically detect the amount of the detached particles.

3. The air cleaning system according to claim 1,
wherein the detection system is configured to:
switch off the corona wire voltage and maintain the collector electrode voltage and the repeller electrode voltage; thereafter
activate the actuating component to detach particles from the collector electrode; thereafter
analyze the collector electrode current signal to determine the amount of the detached particles.

4. The air cleaning system according to claim 3, wherein the detection system is further configured to determine particle size distribution of the detached particles by relating different current pulses of the collector electrode current signal over time to different particle sizes.

5. The air cleaning system according to claim 1,
wherein the detection system is configured to:
switch off the corona wire voltage, switch off the collector electrode voltage and switch off the repeller electrode voltage; thereafter
activate the actuating component to detach particles from the collector electrode; thereafter
supply the collector electrode with the repeller electrode voltage before switch-off and supplying the repeller electrodes with the collector electrode voltage before switch-off, and
analyze the repeller electrode current signal to determine the amount of the detached particles.

6. The air cleaning system according to claim 5, wherein the detection system is further configured to determine particle size distribution of the detached particles by relating different current pulses of the repellent electrode current signal over time to different particle sizes.

7. A particle detector, comprising:
at least one collector electrode, at least one repeller electrode and at least one corona wire; and
a detection system comprising:
an actuating component configured for actuating the collector electrode such that present particles on the collector electrode are detached from the collector electrode when the actuating component is activated; and
a detector configured to determine the type of particles present on the collector electrode from detached collector electrode particles in air.

8. The particle detector according to claim 7, wherein the particle detector is a particle detector for detecting a particular type of particle; and wherein a magnitude of force exerted by the actuating component on the collector electrode is adapted to the particular type of particle.

9. A method for determining a status of an electrostatic precipitation air filter comprising a collector electrode, a repeller electrode and a corona wire, the method comprising:
determining the status of the precipitation air filter by:
determining an amount of gathered particles on the collector electrode; and
determining the status of the electrostatic precipitation air filter based on the determined amount of gathered particles; and
wherein determining the amount of gathered particles present on the collector electrode comprises:
detaching the gathered particles from the collector electrode thereby forming an airborne particle cloud, and
determining the amount of particles in the particle cloud.

10. The method according to claim 9, further comprising:
switching off the corona wire voltage, the collector electrode voltage and the repeller electrode voltage prior to the detaching of the gathered particles from the collector electrode, and
wherein determining the amount of particles in the particle cloud is done by performing optical detection on the particle cloud.

11. The method according to any of claim 9, further comprising:
switching off the corona wire voltage and maintaining the collector electrode voltage and the repeller electrode voltage prior to the detaching of the gathered particles from the collector electrode, and
wherein the amount of particles in the particle cloud is determined from the collector electrode current signal.

12. A method for determining particle size distribution, comprising the method according to claim 11, and wherein the particle size distribution of detached particles is determined by relating different current pulses of the collector electrode current signal over time to different particle sizes.

13. The method according to claim 9, further comprising:
switching off the corona wire voltage, switching off the collector electrode voltage and switching off the repeller electrode voltage prior to the detaching of the gathered particles from the collector electrode, and
supplying the collector electrode with the repeller electrode voltage before switch-off and supplying the repeller electrode with the collector electrode before switch-off after the detaching of the gathered particles from the collector electrode, and
wherein the amount of particles in the particle cloud is determined from the repeller electrode current signal.

14. A method for determining particle size distribution, comprising the method according to claim 13, wherein the particle size distribution of detached particles is determined by relating different current pulses of the repellent electrode current signal over time to different particle sizes.
